(19) United States
(12) Patent Application Publication
(10) Pub. No.: US 2026/0177944 A1
(43) Pub. Date: Jun. 25, 2026

(54) DEVELOPING DEVICE

(71) Applicant: CANON KABUSHIKI KAISHA, Tokyo (JP)

(72) Inventor: Naoki Mugita, Ibaraki (JP)

(21) Appl. No.: 19/417,559

(22) Filed: Dec. 12, 2025

(30) Foreign Application Priority Data
Dec. 25, 2024 (JP) 2024-228738

(51) Int. Cl. G03G 15/08

(52) U.S. Cl. CPC G03G 15/0812; G03G 15/0808; G03G 15/0815; G03G 15/0889; G03G 15/0891; G03G 2215/0827; G03G 2215/085

(57) ABSTRACT

A developing device includes a developing container, a developing member, a supplying screw, a developer amount regulating portion, a magnet, and an inclined portion. An inclination starting point of the inclined portion is positioned below a point on an outer peripheral surface of the developing member where an absolute value of magnetic flux density of an upstream pole of the magnet becomes a maximum value, and above the regulating portion. The inclination starting point is positioned between the supplying screw and the developing member. An absolute value of maximum magnetic flux density of a regulating pole of the magnet is higher than the absolute value of the maximum magnetic flux density of the upstream. An absolute value of a maximum magnetic flux density of a downstream pole of the magnet is higher than the absolute value of the maximum magnetic flux density of the regulating pole.

### BACKGROUND

### Field of the Technology

The present disclosure relates to a developing device for developing an electrostatic latent image, with a developer, formed on an image bearing member.

### Description of the Related Art

As the developing device, a constitution two developing rollers for developing the electrostatic latent image, with the developer, formed on the image bearing member are arranged side by side in a rotational direction of the image bearing member is proposed (U.S. Patent Publication No. US2013/0330107). In the developing device disclosed in US2013/0330107, a constitution in which the developer is supplied to the developing roller, of the two developing rollers, positioned in a lower portion in a vertical direction is employed. The developer supplied to the developing roller is carried on the developing roller is regulated in layer thickness by a regulating member provided through a predetermined gap with the developing roller on a side below a rotation center of the developing roller and upstream of a lowest point of the developing roller with respect to the rotational direction of the developing roller, and is fed to a developing position where the developing roller opposes a photosensitive drawn.

Further, in the case of the constitution disclosed in US2013/0330107, between a supplying screw and the developing roller, a spatial capacity regulating portion for regulating a capacity of a space in which the developer is supplied from the supplying screw to the developing roller is provided. In addition, an inclined portion inclined downward toward the regulating member from an end portion of the spatial capacity regulating portion on a developing roller side of the spatial capacity regulating portion. The developer regulated in amount is fed t a regulating member side along the inclined portion.

As described in US2013/0330107, in the case where when the developer is supplied from the supplying screw to the developing roller, the amount of the developer is regulated by the spatial capacity regulating portion and in addition, the developer is fed toward the regulating member side along the inclined portion, it is desired that a flow of the developer toward the regulating member is not hindered. When the flow of the developer is hindered, there is a liability that a feeding amount of the developer toward the regulating member side lowers and the amount of the developer carried on the developing roller cannot be stably regulated by the regulating member. Particularly, in the case where the developer is deteriorated by use and a flowability of the developer is lowered, a feeding property of the developer toward the regulating member side is lowered, but even in such a case, it is desired that a feeding amount of the developer is maintained.

### SUMMARY

An aspect of the present disclosure is directed to stably feed a developer toward a regulating member for regulating an amount of the developer carried on an outer peripheral surface of a rotatable developing member.

According to another aspect of the present disclosure, there is provided a developing device comprising: a developing container configured to accommodate a developer including toner and a carrier; a rotatable developing member configured to carry and feed the developer to a developing position where an electrostatic latent image formed on an image bearing member is developed; a supplying screw configured to supply the developer to the rotatable developing member while stirring and feeding the developer; a regulating portion configured to regulate an amount of the developer carried on an outer peripheral surface of the rotatable developing member, the regulating portion being positioned below a rotation center of the rotatable developing member with respect to a vertical direction and upstream of a lowest point of the rotatable developing member with respect to a rotational direction of the rotatable developing member; a magnet provided non-rotatably and stationarily inside the rotatable developing member, the magnet including a regulating pole provided opposed to the regulating portion, an upstream pole provided upstream of the regulating pole and adjacent to the regulating pole, with respect to the rotational direction of the rotatable developing member, and having a polarity different from that of the regulating pole, and a downstream pole provided downstream of the regulating pole and adjacent to the regulating pole, with respect to the rotational direction of the rotatable developing member, and having a polarity different from that of the regulating pole; and an inclined portion inclined downward in a vertical direction toward the regulating portion, wherein a starting point of inclination of the inclined portion downward in the vertical direction is positioned below, in the vertical direction, a point on the outer peripheral surface of the rotatable developing member where an absolute value of magnetic flux density of the upstream pole in a normal direction to the outer peripheral surface of the rotatable developing member becomes a maximum value, and above the regulating portion in the vertical direction, and the starting point of inclination of the inclined portion downstream in the vertical direction is positioned between the supplying screw and the rotatable developing member with respect to a horizontal direction, wherein an absolute value of a maximum value of magnetic flux density of the regulating pole in a normal direction to the outer peripheral surface of the rotatable developing member is higher than the absolute value of the maximum value of the magnetic flux density of the upstream pole in the normal direction to the outer peripheral surface of the rotatable developing member, and wherein an absolute value of a maximum value of magnetic flux density of the downstream pole in a normal direction to the outer peripheral surface of the rotatable developing member is higher than the absolute value of the maximum value of the magnetic flux density of the regulating pole in the normal direction to the outer peripheral surface of the rotatable developing member.

According to a further aspect of the present disclosure, there is provided a developing device comprising: a developing container configured to accommodate a developer including toner and a carrier; a rotatable developing member configured to carry and feed the developer to a developing position where an electrostatic latent image formed on an image bearing member is developed; a supplying screw configured to supply the developer to the rotatable developing member while stirring and feeding the developer; a regulating portion configured to regulate an amount of the developer carried on an outer peripheral surface of the rotatable developing member, the regulating portion being positioned below a rotation center of the rotatable developing member with respect to a vertical direction and upstream of a lowest point of the rotatable developing member with respect to a rotational direction of the rotatable developing member; a magnet provided non-rotatably and stationarily inside the rotatable developing member, the magnet including a regulating pole provided opposed to the regulating portion, an upstream pole provided upstream of the regulating pole and adjacent to the regulating pole, with respect to the rotational direction of the rotatable developing member, and having a polarity different from that of the regulating pole, and a downstream pole provided downstream of the regulating pole and adjacent to the regulating pole, with respect to the rotational direction of the rotatable developing member, and having a plurality different from that of the regulating pole; and an inclined portion inclined downward in a vertical direction toward the regulating portion, wherein a starting point of inclination of the inclined portion downward in the vertical direction is positioned below, in the vertical direction, a point on the outer peripheral surface of the rotatable developing member where an absolute value of magnetic flux density of the upstream pole in a normal direction to the outer peripheral surface of the rotatable developing member becomes a maximum value, and above the regulating portion in the vertical direction, and the starting point of inclination of the inclined portion downstream in the vertical direction is positioned between the supplying screw and the rotatable developing member with respect to a horizontal direction, wherein in a case where of a magnetic force acting on the carrier on the outer peripheral surface of the rotatable developing member, the magnetic force in a tangential direction to the outer peripheral surface of the rotatable developing member is defined as Fθ, a sign of Fθ when a direction of Fθ is the same direction as the rotational direction of the rotatable developing member is defined as a positive, and a sign of Fθ when the direction of Fθ is a direction opposite to the rotational direction of the rotatable developing member is defined as a negative, with respect to the rotational direction of the rotatable developing member, Fθ>0 is satisfied over a range from a point where a line connecting the rotation center of the rotatable developing member and the starting point of inclination of the inclined portion downward in the vertical direction crosses the outer peripheral surface of the rotatable developing member to a point where a line connecting the rotation center of the rotatable developing member and the regulating portion crosses the outer peripheral surface of the rotatable developing member.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic structural sectional view of an image forming apparatus in an embodiment.

FIG. 2 is a schematic structural sectional view of a developing device according to the embodiment.

FIG. 3 is a schematic view showing a magnetic pole arrangement of a first developing roller in the embodiment.

FIG. 4 is a schematic view showing a magnetic pole arrangement of a second developing roller in the embodiment.

FIG. 5 is a schematic view showing a magnetic pole arrangement of a peeling roller in the embodiment.

FIG. 6 is a schematic structural sectional view of a periphery of the first roller and a developer supplying screw in the embodiment.

FIG. 7 is a schematic structural sectional view of the periphery of the first roller and the developer supplying screw, showing a relationship between the first roller, a regulating member, and an inclined portion in the embodiment 1.

FIG. 8 is a graph showing magnetic flux density Br in a periphery of a regulating pole of a first roller in an embodiment 1.

FIG. 9 is a graph showing a magnetic force Fθ in a periphery of the regulating pole of the first roller in the embodiment 1.

FIG. 10 is a graph showing magnetic flux density Br in a periphery of a regulating pole of a first roller in an embodiment 2.

FIG. 11 is a graph showing a magnetic force Fθ in a periphery of a regulating pole of the first roller in the embodiment 2.

### DESCRIPTION OF THE EMBODIMENTS

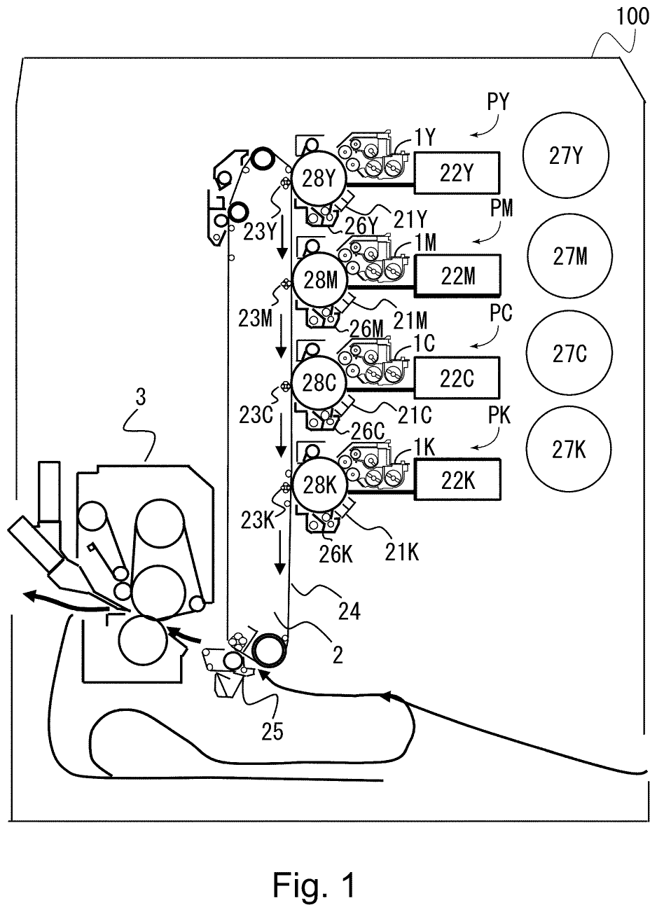

An embodiment will be described using FIG. 1 to FIG. 11. First, a general structure of an image forming apparatus in this embodiment will be described with reference to FIG. 1.

### [Image Forming Apparatus]

An image forming apparatus 100 is a full-color image forming apparatus, and in the case of this embodiment, the image forming apparatus 100 is, for example, an MFP (multi-function peripheral) having a copy function, a printer function, and a scan function. The image forming apparatus 100 includes, as shown in FIG. 1, image forming portions PY, PM, PC, and PK for performing an image forming step of forming toner images of four colors of yellow, magenta, cyan, and black, respectively, which are vertically arranged.

The image forming portions PY, PM, PC, and PK for the respective colors include primary chargers 21Y, 21M, 21C, and 21K, developing devices 1Y, 1M, 1C, and 1K, optical write portions (exposure devices) 22Y, 22M, 22C, and 22K, photosensitive drums 28Y, 28M, 28C, and 28K, and cleaning devices 26Y, 26M, 26C, and 26K, respectively. Further, the image forming apparatus 100 includes a transfer device 2 and a fixing device 3. Incidentally, structures of the image forming portions PY, PM, PC, and PK are similar to each other, and therefore, in the following, description will be described using the image forming portion PY as a representative.

The photosensitive drum 28Y as an image bearing member is a photosensitive member, having a photosensitive layer formed of a resin such as polycarbonate, containing an organic photoconductor (OPC), and is constituted so as to be rotated at a predetermined speed. In this embodiment, a line speed of a surface of the photosensitive drum 28Y is set to 650 mm/s. The primary charger 21Y includes a corona discharge electrode disposed at a periphery of the photosensitive drum 28Y and electrically charges the surface of the photosensitive drum 28Y by generated ions.

In the optical write portion 22Y, a scanning optical device is assembled, and by exposing the charged photosensitive drum 28Y to light on the basis of image data, a potential of an exposed portion is lowered, so that an electric charge pattern (electrostatic latent image) corresponding to the image data is formed. The developing device 1Y develops the electrostatic latent image, formed on the photosensitive drum 28Y, by transferring a developer accommodated therein onto the photosensitive drum 28Y. The developer is prepared by mixing a carrier with toner of an associated color, and the electrostatic latent image is visualized (developed) by the toner.

The transfer device 2 includes primary transfer rollers 23Y, 23M, 23C, and 23K, an intermediary transfer belt 24, and a secondary transfer roller 25. The intermediary transfer belt 24 is wound around the primary transfer rollers 23Y, 23M, 23C, and 23K and a plurality of rollers, and is supported so as to be travelable.

The primary transfer rollers 23Y, 23M, 23C, and 23K are disposed in a named order from above in FIG. 1 and correspond to the colors of Y (yellow), M (magenta), C (cyan), and K (black), respectively. The secondary transfer roller 25 is disposed outside the intermediary transfer belt 24 and is constituted so that a recording material is capable of passing through between the secondary transfer roller 25 and the intermediary transfer belt 24. Incidentally, the recording material is, for example, a sheet such as paper or a plastic sheet.

The toner images of the respective colors formed on the photosensitive drums 28Y, 28M, 28C, and 28K are successively transferred onto the intermediary transfer belt 24 by the primary transfer rollers 23Y, 23M, 23C, and 23K, respectively, so that a color toner image including superimposed layers of the colors of yellow, magenta, cyan, and black. The thus-formed color toner image is transferred by the secondary transfer roller 25 onto the recording material fed from a cassette or the like in which recording materials are accommodated. The recording material on which the color toner image is transferred is pressed and heated in the fixing device 3. By this, the toner on the recording material is melted, so that the color image is fixed on the recording material.

Developer storage portions 27Y, 27M, 27C, and 27K are provided correspondingly to the developing devices 1Y, 1M, 1C, and 1K, respectively, and in which bottles accommodating developers corresponding to the colors of yellow, magenta, cyan, and black are exchangeably mounted in a named order from above, respectively. The developer storage portions 27Y, 27M, 27C, and 27K are constituted so that the developers are capable of being fed (supplied) therefrom to the developing devices 1Y, 1M, 1C, and 1K corresponding to the colors of the developers stored therein, respectively.

For example, a toner weight ratio of the developer accommodated in each bottle is 80 to 95%, and a toner weight ratio of the developer in each of the developing devices 1Y, 1M, 1C, and 1K is 5 to 10%. For that reason, when the toner is consumed by development in each of the developing devices 1Y, 1M, 1C, and 1K, the developer containing the toner in an amount corresponding to a consumption amount of the toner is supplied, so that the toner weight ratio of the developer in each of the developing devices 1Y, 1M, 1C, and 1K is maintained in a constant amount.

### [Developing Device]

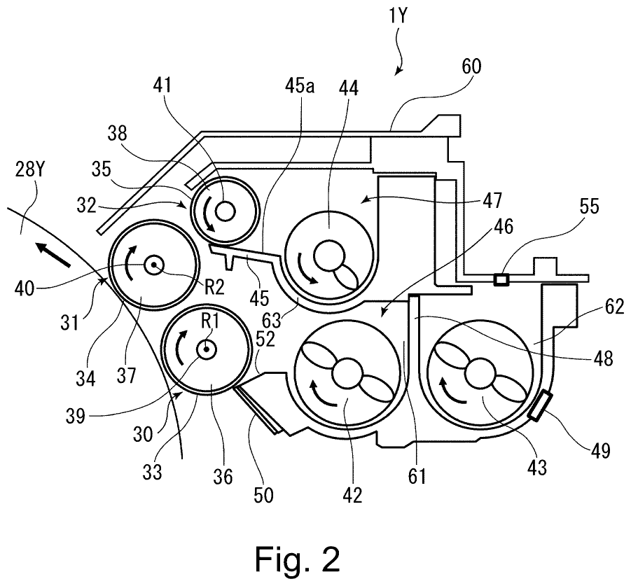

Next, the developing devices 1Y, 1M, 1C, and 1K will be specifically described using FIGS. 2 to 5.

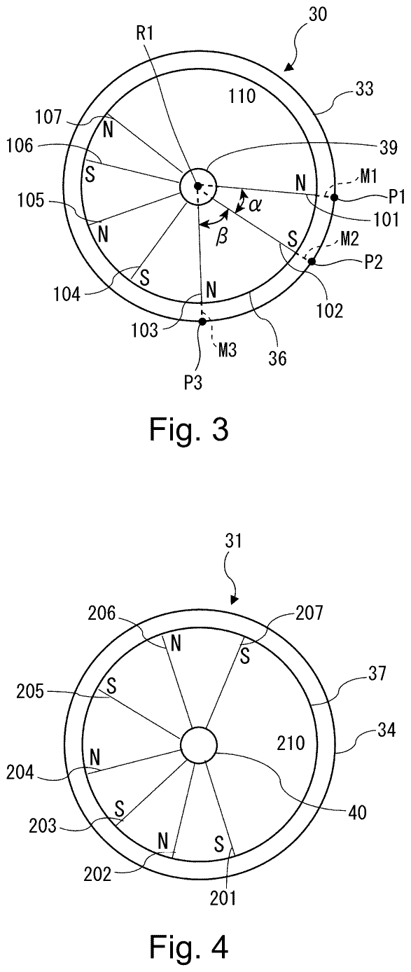

Incidentally, structures of the developing devices 1Y, 1M, 1C, and 1K are the same, and therefore, in the following, the developing device 1Y will be described as a representative. FIG. 2 is a conceptual view illustrating the developing device 1Y shown in FIG. 1, and FIGS. 3 to 5 are conceptual views illustrating magnetic pole structures of a first magnet 36, a second magnet 37, and a third magnet 38 which are provided inside the developing device 1Y, respectively.

The developing device 1Y includes, as shown in FIG. 2, a first developing roller 30, a second developing roller 31, a peeling roller (collecting roller) 32, a developer supplying screw 42, a developer stirring screw 43, and a developer collecting screw 44, and these members are accommodated in a developing container 60.

The first developing roller 30 as a developing roller is a developer carrying member which is rotationally driven, and is provided in a position adjacent to the photosensitive drum 28Y so that a rotational axis thereof is substantially parallel to a rotational axis of the photosensitive drum 28Y. The first developing roller 30 includes a rotatable first sleeve (first developing sleeve) 33, and a first magnet (fixed magnet, first developing magnet) 36 provided non-rotationally inside the first sleeve 33 and for attracting the developer to a surface of the first sleeve 33 by a magnetic force. Then, the first developing roller 30 attracts (carries) the developer, scooped from the developer supplying screw 42, on the basis of the magnetic force, and develops the electrostatic latent image, formed on the rotating photosensitive drum 28Y (image bearing member), with the developer.

To the first sleeve 33 (and a second sleeve 34 described later) of the developing device 1Y, for example, a DC developing bias of the same polarity as a charge polarity of the primary charger 21Y or a developing bias in the form of an AC voltage superposed with a DC voltage of the same polarity as the charge polarity of the primary charger 21Y is applied. As a result, reverse development in which the toner charged to the same polarity as the charge polarity of the primary charger 21Y is deposited on the electrostatic latent image formed by the exposure device 22Y is performed. In this embodiment, a constitution in which the reverse development in which the charge polarity of the primary charger 21Y and the DC voltage of the developing bias are negative and the negatively charged toner is deposited on the electrostatic latent image is performed was employed.

The first sleeve 33 as a developing sleeve is a non-magnetic cylindrical member having an outer diameter of 25 mm (radius r1=12.5 mm) and is rotationally driven about a rotation shaft 39. A rotational direction of the first sleeve 33 is the clockwise direction as indicated by an arrow in FIG. 2 and is a direction opposite to a rotational direction of the photosensitive drum 28 in this embodiment. For this reason, the first sleeve 33 and the photosensitive drum 28Y rotate in the same direction in mutually opposing positions thereof. The first sleeve 33 is rotated from below toward above with respect to the vertical direction in a position opposing the photosensitive drum 28Y.

In this embodiment, a linear speed of a surface of the first sleeve 33 of the first developing roller 30 is made 1.0 time (=650 mm/s) the line speed of the surface of the photosensitive drum 28Y. When a ratio of the line speed of the surface of the first sleeve 33 to the line speed of the surface of the photosensitive drum 28Y is suppressed to about 1.0 time to about 1.2 times, such a suppressed line speed ratio is advantageous from a viewpoint of prevention of toner deterioration. On the other hand, a supply amount of the toner to the photosensitive drum 28Y is decreased, so that there is a liability that a developing property lowers, but in this embodiment, the two developing rollers 30 and 31 are provided, so that even when the line speed ratio is suppressed, the supply amount of the toner to the photosensitive drum 28Y can be maintained.

The first magnet 36 is disposed inside the first sleeve 33 and includes, as shown in FIG. 3, a plurality of sector-shaped magnetic poles 101 to 107. Each of solid lines shown in FIG. 3 shows a peak position (position of a maximum value) of a distribution of a normal component of magnetic flux density of each of the magnetic poles 101 to 107 of the first magnet 36. Between an inner periphery of the first sleeve 33 and an outer periphery of the first magnet 36, a space permitting rotation of the first sleeve 33 is provided.

The developer attracted onto the first sleeve 33 (developing sleeve) is fed (conveyed) toward the photosensitive drum 28Y by a rotation operation of the first sleeve 33, and develops the electrostatic latent image formed on the photosensitive drum 28Y. After the developer develops the electrostatic latent image formed on the photosensitive drum 28Y, the developer on the first sleeve 33 is fed to the neighborhood of the second developing roller 31 by the rotation operation of the first sleeve 33. Then, in the neighborhood of a closest position between the first developing roller 30 and the second developing roller 31, the developer is peeled off from the surface of the first sleeve 33 and then delivered to a surface of a second sleeve 34 by a magnetic field generated by the first magnet 36 included in the first developing roller 30 and by the second magnet 37 included in the second developing roller 31. Incidentally, the first sleeve 33 and the second sleeve 34 are disposed with a gap of 3 mm in a closest portion therebetween.

The second developing roller 31 is a developer carrying member which is rotationally driven, and is provided downstream of the first developing roller 30 with respect to the rotational direction of the photosensitive drum 28Y and a rotation center R2 of the second sleeve 34 is provided so as to be positioned above a rotation center R1 of the first sleeve 33 with respect to the vertical direction. To the second sleeve 34, the developer is delivered from the first developing roller 30 by the magnetic force (FIG. 2). In this embodiment, a whole of the second developing roller 31 is positioned above the rotation center R1 of the first developing roller 30. The second developing roller 31 is, similarly as the first developing roller 30, provided in a position adjacent to the photosensitive drum 28Y so that a rotational axis thereof is substantially parallel to a rotational axis of the photosensitive drum 28Y. Accordingly, the second developing roller 31 and the first developing roller 30 are substantially parallel to each other in rotational axis.

Such a second developing roller 31 includes a rotatable second sleeve (second developing sleeve) 34, and the second magnet (fixed magnet, second developing magnet) 37 provided non-rotationally inside the second sleeve 34 and for attracting the developer to a surface of the second sleeve 34 by a magnetic force. Then, on the basis of the magnetic force, to the second developing roller 31, the developer is delivered from the first developing roller 30 (the first sleeve 33), and the second developing roller 31 attracts (carries) the developer, and develops the electrostatic latent image formed on the rotating photosensitive drum 28Y, with the developer. Incidentally, on a side of the second developing roller 31, the peeling roller 32 described later is positioned.

The second sleeve 34 is a non-magnetic cylindrical member having an outer diameter of 25 mm (radius r2=12.5 mm) and is rotationally driven about a rotation shaft 40. A rotational direction of the second sleeve 34 is the clockwise direction similarly as the first sleeve 33 as indicated by an arrow in FIG. 2 and is a direction opposite to a rotational direction of the photosensitive drum 28Y in this embodiment. For this reason, the second sleeve 34 and the photosensitive drum 28Y rotate in the same direction in mutually opposing positions thereof. The second sleeve 34 is rotated from below to above with respect to the vertical direction in a position opposing the photosensitive drum 28Y. Further, the second sleeve 34 and the first sleeve 33 rotate in opposite directions in mutually opposing positions thereof. In this embodiment, a line speed of the surface of the second sleeve 34 of the second developing roller 31 is made 1.2 times (=780 mm/s) a line speed of the surface of the photosensitive drum 28Y.

The second magnet 37 is disposed inside the second sleeve 34 and includes, as shown in FIG. 4, a plurality of sector-shaped magnetic poles 201 to 207. Each of solid lines shown in FIG. 4 shows a peak position (position of a maximum value) of a distribution of a normal component of magnetic flux density of each of the magnetic poles 201 to 207 of the second magnet 37. Between an inner periphery of the second sleeve 34 and an outer periphery of the second magnet 37, a space permitting rotation of the second sleeve 34 is provided.

The developer attracted onto the second sleeve 34 is fed toward the photosensitive drum 28Y by a rotation operation of the second sleeve 34, so that the electrostatic latent image formed on the photosensitive drum 28Y is developed with the developer. After the electrostatic latent image formed on the photosensitive drum 28Y is developed with the developer, the developer remaining on the second sleeve 34 is fed to the neighborhood of the peeling roller 32 by a rotation operation of the second sleeve 34. Then, in the neighborhood of a closest position between the second developing roller 31 and the peeling roller 32, the developer is delivered from the second sleeve 34 to a third sleeve 35 of the peeling roller 32 by a magnetic field generated by the second magnet 37 included in the second developing roller 31 and by the third magnet 38 included in the peeling roller 32.

The peeling roller 32 as a peeling portion is provided on a side opposite from the photosensitive drum 28Y with respect to a rotation center of the second sleeve 34 and peels off, from the second developing roller 31, the developer after the electrostatic latent image on the photosensitive drum 28Y is developed by the second developing roller 31. Specifically, the peeling roller 32 is a developer carrying member which is rotationally driven, and is provided between the second developing roller 31 and the developer collecting screw 44 so that a rotation center thereof is positioned above the rotation center R of the second developing roller 31.

Further, the peeling roller 32 is disposed so that a rotational axis thereof is substantially parallel to a rotational axis of the photosensitive drum 28Y. Such a peeling roller 32 includes a rotatable third sleeve 35 and the third magnet (fixed magnet) 38 provided non-rotationally inside the third sleeve 35 and for attracting the developer to a surface of the third sleeve 35 by a magnetic force, and is constituted so that the developer is delivered from the second developing roller 31 thereto on the basis of the magnetic force.

The third sleeve 35 is a non-magnetic cylindrical member having an outer diameter of 18 mm (radius: 9 mm) and is rotationally driven about a rotation shaft 41. A rotational direction of the third sleeve 35 is the counterclockwise direction as indicated by an arrow in FIG. 2 and is a direction opposite to a rotational direction of the second sleeve 34 n this embodiment. For this reason, the third sleeve 35 and the second sleeve 34 rotate in the same direction in mutually opposing positions thereof.

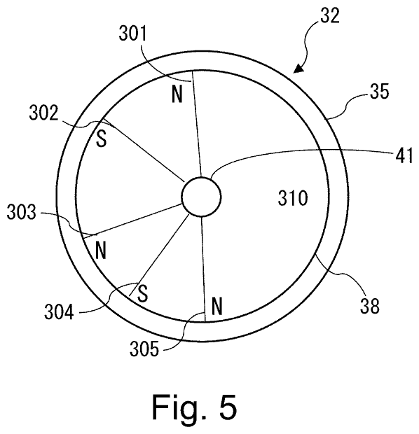

The third magnet 38 is disposed inside the third sleeve 35 and includes, as shown in FIG. 5, a plurality of magnetic poles 301 to 305. Each of solid lines shown in FIG. 5 shows a peak position (position of a maximum value) of a distribution of a normal component of magnetic flux density of each of the magnetic poles 301 to 306 of the third magnet 38. Between an inner periphery of the third sleeve 35 and an outer periphery of the third magnet 38, a space permitting rotation of the third sleeve 35 is provided.

The developer attracted onto the third sleeve 35 is fed to a downstream side of the rotational direction by a rotation operation of the third sleeve 35 is peeled off from the third sleeve 35 in a position close to the developer collecting screw 44 by the third magnet 38 included in the peeling roller 32, so that the developer is dropped toward a guiding member 45 positioned below with respect to the vertical direction, by a self-weight thereof. Then, the developer dropped on the guiding member 45 is guided toward the developer collecting screw 44 by its own weight.

The guiding member 45 and the developer collecting screw 44 constitute a developer collecting portion 47 as a collecting portion for collecting the developer peeled off from the third sleeve 35 on the peeling roller 32. In the developer collecting portion 47, a rotation center of the developer collecting screw 44 is disposed so as to be positioned below a rotation center of the peeling roller 32 in the vertical direction, and feeds the developer delivered (collected) from the peeling roller 32, while stirring the developer.

The guiding member 45 as a guiding portion is disposed below the peeling roller 32 with respect to the vertical direction and a closest position P2 between the guiding member 45 and the peeling roller 32 is disposed above the rotation center R2 of the second sleeve 34 with respect to the vertical direction, and the guiding member 45 guides the developer, peeled off by the peeling roller 32, toward the developer collecting screw 44. Such a guiding member 45 includes an inclined surface 45a along which the developer slides down by its own weight in order to reliably guide the peeled developer toward the developer collecting screw 44. The inclined surface 45a is inclined with respect to a horizontal direction so that a position thereof on the developer collecting screw 44 side is lower than a lower position of the peeling roller 32.

The developer collecting screw 44 as a collecting member and a feeding portion feeds the collected developer to a developer circulating portion 46 described below. That is, the developer collecting screw 44 is a screw feeding member used for feeding the developer, collected by being slid down along the inclined surface 45a of the guiding member 45, in one direction while stirring the developer.

The developer circulating portion 46 is a supplying portion for supplying the developer to the first developing roller 30, and includes a regulating member 50, the developer supplying screw 42, and the developer stirring screw 43. In the developer circulating portion 46, the developer is supplied to the first developing roller 30 while the developer is fed in the substantially horizontal direction while being stirred in the developer supplying screw 42 and the developer stirring screw 43. That is, the developer supplying screw 42 supplies the developer to the first developing roller 30 while stirring the developer. Further, as described above, the developer collected by the developer collecting portion 47 is dropped by its own weight and is guided to the developer circulating portion 46.

The developer supplying screw 42, the developer stirring screw 43, and the developer collecting screw 44 are screw feeding members for feeding the developer in one direction while stirring the developer, and the developer supplying screw 42 and the developer stirring screw 43 are positioned below the developer collecting screw 44 with respect to the vertical direction. Further, the developer supplying screw 42, the developer stirring screw 43, and the developer collecting screw 44 are disposed so that their rotational axes are substantially parallel to each other. The rotational axes of these screws are also substantially parallel to the rotational axis of the first developing roller 30.

The developer supplying screw 42 is positioned between the first developing roller 30 and the developer stirring screw 43, and between itself and the developer stirring screw 43, a partition wall 48 of the developing container 60 is provided. The partition wall 48 of the developing container 60 is extended along rotational axis directions of the developer supplying screw 42 and the developer stirring screw 43. The partition wall 48 is provided with a communication opening (not shown) for establishing communication between a first feeding path 61 along which the developer is fed by the developer supplying screw 42 and a second feeding path 62 along which the developer is fed by the developer stirring screw 43.

The developer stirred by the developer collecting screw 44 passes through a communication opening (not shown) formed in a partition wall 63 of the developing container 60 positioned between the developer collecting screw 44 and the developer supplying screw 42 and then is dropped toward the developer supplying screw 42 by its own weight. Incidentally, the above-described guiding member 45 is formed integrally with the partition wall 63, and above the partition wall 63, the developer collecting screw 44 is disposed.

A position of the communication opening through which the developer stirred by the developer collecting screw 44 is dropped by its own weight and is guided into the developer circulating portion 46 may preferably be disposed while avoiding a region (an intermediary portion of the developer supplying screw 42 with respect to a rotational axis direction) in which the developer is supplied toward the first developing roller 30. In this embodiment, the position of the communication opening is a position where the communication opening position is included in a range of a downstream end portion (terminal portion), with respect to a developer feeding direction, of the first feeding path 61 in which the developer supplying screw 42 is disposed.

Developer feeding directions of the developer supplying screw 42 and the developer stirring screw 43 are mutually opposite directions. Further, a starting end side (upstream end side in the developer feeding direction) and a terminal end side (downstream end side in the developer feeding direction) of the first feeding path 61 in which the developer supplying screw 42 is disposed, and a terminal end side and a starting end side of the second feeding path 62 in which the developer stirring screw 43 is disposed communicate with each other, respectively, via communication openings provided in the partition wall 48. Accordingly, the developer is circulated in the rotational directions of the developer supplying screw 42 and the developer stirring screw 43 indicated by arrows in FIG. 2 and in the substantially horizontal direction in the developing container 60, so that a part of the developer is supplied toward the first developing roller 30.

A developer supply opening 55 (see FIG. 2) is provided above the developer stirring screw 43 in the developing container 60 and is connected to the developer storage portion 27Y (see FIG. 1). Further, the developer supply opening 55 is constituted so as to be capable of supplying the developer, accommodated in a bottle mounted in the developer storage portion 27Y, to the second feeding path 62 in which the developer stirring screw 43 is disposed.

As described above, a toner weight ratio of the developer accommodated in the bottle of the developer storage portion 27Y is larger than a toner weight ratio of the developer in the developing device 1Y, and therefore, by adjusting an amount of the developer supplied to the developer stirring screw 43, the toner weight ratio of the developer in the developing device 1Y can be maintained at a certain level.

A toner concentration detecting sensor 49 (see FIG. 2) is provided for detecting a toner concentration of the developer contained in the developer circulating portion 46. The toner concentration detecting sensor 49 is a sensor for detecting (magnetic) permeability of the developer. The toner concentration corresponds to a consumption amount of the toner in the developing device 1Y, and therefore, is utilized in control of supply of the developer from the developer storage portion 27Y. For example, when the toner concentration is detected that the toner concentration is lowered than a predetermined value, the developer is supplied from the developer storage portion 27Y. Incidentally, the permeability of the developer changes depending on the toner concentration, and therefore, by utilizing the permeability, it is possible to detect the toner concentration.

The regulating member (regulating blade) 50 is disposed adjacent to the first developing roller 30 and is used for regulating an amount of the developer supplied from the developer circulating portion 46 to the first developing roller 30. The regulating member 50 can be constituted so as to regulate an amount of the developer attracted to the first developing roller 30, for example, on the basis of a gap between the surface of the first sleeve 33 of the first developing roller 30 and an end portion of the regulating member 50.

Incidentally, as specifically described later, between the developer supplying screw 42 of the developer circulating portion 46 and the first developing roller 30, a spatial capacity regulating portion 51 for regulating a capacity of a space in which the developer is supplied from the developer supplying screw 42 to the first developing roller 30 is provided. Further, an inclined portion 52 inclined downward from an end portion of the spatial capacity regulating portion 51 on the first developing roller side toward the regulating member 50 is also provided. The developer regulated in amount by the spatial capacity regulating portion 51 is fed toward the regulating member 50 side along the inclined portion 52.

A circulating path of the developer in the developing container 60 is such that the developer is fed in the substantially horizontal direction while being stirred in the developer circulating portion 46 and thereafter is supplied to the first developing roller 30, and then is delivered from the first developing roller 30 to the second developing roller 31 positioned above the first developing roller 30, on the basis of the magnetic force. Then, the developer is delivered from the second developing roller 31 to the peeling roller 32 positioned beside the second developing roller 31, on the basis of the magnetic force again, and thereafter, is peeled off from the peeling roller 32 by the third magnet 38 included in the peeling roller 32, and then, the developer is collected by the developer collecting portion 47 and then is guided again into the developer circulating portion 46.

Further, as described above, in this embodiment, a two-component development type is used as a development type, and as the developer, a developer obtained by mixing non-magnetic toner having a negative charge polarity with a carrier having a magnetic property is used. At this time, the non-magnetic toner is negatively charged by triboelectric charge with the magnetic carrier and the magnetic carrier is positively charged. The non-magnetic toner is toner obtained by containing a colorant, a wax component, and the like in a resin such as polyester or styrene-acrylic resin, by forming the mixture in powder through pulverization or polymerization, and then by adding fine powder of titanium oxide, silica, or the like to a surface of the powder. The magnetic carrier is a carrier obtained by coating a resin material on a surface layer of a core comprising resin particles obtained by being kneaded with ferrite particles or magnetic powder. The toner concentration of the developer (a weight ratio of the toner to the developer) in an initial state is 8% in this embodiment.

Incidentally, the magnetic carrier may preferably have a magnetization amount per unit weight of 40 Am²/kg to 80 Am²/kg in an applied magnetic field of 1000 Oe (oersted). When the magnetization amount of the magnetic carrier is made small, there is an effect of suppressing scavenging by a magnetic brush, but deposition of the magnetic carrier on the non-magnetic cylinder by the magnetic field generating means becomes difficult, so that an image defect such as deposition of the magnetic carrier onto the photosensitive drum occurs or the like in some instances. Further, when the magnetization amount of the magnetic carrier is larger than the above-described range, as described above, the image defect is caused by pressure of the magnetic brush. In this embodiment, a magnetic carrier having the magnetization amount per unit weight of 63 Am²/kg was used.

The magnetization amount of the magnetic carrier was measured by using a vibrating sample magnetometer (vibration magnetic field-type automatic magnetic property measurement system) (“BHV-30”, manufactured by Riken Denshi Co., Ltd.). A magnetic characteristic value is obtained in the following manner. An external magnetic field of 1000 Oe is formed and strength of magnetization at that time is acquired. The magnetic carrier is put in a packed state so as to become sufficiently dense in a cylindrical plastic container. In this state, magnetic moment is measured, and an actual weight when a sample is placed is measured, so that the strength of magnetization (Am²/kg) is acquired. True specific gravity is acquired by a dry automatic pycnometer (“Accupyc 1330”, manufactured by Shimadzu Corporation). In this embodiment, a magnetic carrier of 4.6 (g/cm³) in true specific gravity (density) was used. Further, the magnetic carrier of 35 μm (radius b=17.5 μm) in weight-average diameter was used.

In general, the two-component development type using the toner and the carrier has a feature such that stress exerted on the toner is less than stress exerted on the toner in a one-component development type using a one-component developer because the toner and the carrier are charged to predetermined polarities by subjecting the toner and the carrier to triboelectric contact. On the other hand, by long-term use, an amount of a contaminant (spent) deposited on the carrier surface increases, and therefore, capacity for charging the toner gradually lowers. As a result, problems of a fog and a toner scattering arise. Although it would be considered that an amount of the carrier accommodated in the developing device is increased in order to prolong a lifetime of the two-component developing device, this causes upsizing of the developing device, and therefore is not desirable.

In order to solve the above-described problems on the two-component developer, in this embodiment, an ACR (auto carrier refresh) type is employed. The ACR type is a type such that an increase in amount of a deteriorated carrier is suppressed by not only supplying a fresh developer little by little from the developer storage portion 27Y into the developing device 1Y but also discharging the developer, deteriorated in charging performance, little by little through a discharge opening (not shown) of the developing device 1Y. By this, the deteriorated carrier in the developing device 1Y is replaced little by little with a fresh carrier, so that the charging performance of the carrier in the developing device 1Y can be maintained at an approximately constant level.

### [Magnetic Poles of Magnets]

Next, magnetic pole constitutions of the first magnet 36, the second magnet 37, and the third magnet 38 included in the first developing roller 30, the second developing roller 31, and the peeling roller 32, respectively, which are shown in FIGS. 3, 4, and 5, respectively, will be described.

As shown in FIG. 3, the first magnet 36 included in the first developing roller 30 has a magnetic pole structure of 7 poles consisting of a plurality of magnetic poles 101, 102, 103, 104, 105, 106, and 107. The magnetic poles 101 to 107 are disposed in a named order in the rotational direction of the first sleeve 33.

The magnetic pole 105 is an N pole and is disposed in a position opposing the photosensitive drum 28Y through the first sleeve 33, and is a magnetic pole for developing the electrostatic latent image formed on the photosensitive drum 28Y.

The magnetic pole 107 as a delivering pole is an N pole and is a magnetic pole for delivering the developer from the first sleeve 33 to the second sleeve 34 by a magnetic field generated in cooperation with the second magnet 37 of the second developing roller 31, and hereinafter, the magnetic pole 107 is referred to as a delivering pole 107 in some cases. The magnetic pole 101 (first magnetic pole) is an N pole and is used for attracting the developer, supplied from the developer supplying screw 42, to the first sleeve 33. That is, the magnetic pole 101 is a magnetic pole for causing the developer, supplied from the developer supplying screw 42, to be carried on the surface of the first sleeve 33, and hereinafter, the magnetic pole 101 is referred to as a scooping pole 101 in some cases.

The magnetic pole 102 (second magnetic pole) is an S pole and is disposed in a position opposing the regulating member 50 through the first sleeve 33, and as described above, the magnetic pole 102 adjusts the amount of the developer fed on the first sleeve 33. That is, the magnetic pole 102 is disposed so as to be adjacent to the scooping pole 101 on a side downstream of the scooping pole 101 with respect to the rotational direction of the first sleeve 33, and hereinafter, the magnetic pole 102 is referred to as a regulating pole 102 in some cases. The magnetic poles 103, 104, and 106 are an S pole, an N pole, an S pole, and an S pole, respectively, and are used for feeding upward the developer attracted by the magnetic pole 101 with rotation of the first sleeve 33. The magnetic pole 103 (third magnetic pole) is a magnetic pole disposed so as to be adjacent to the regulating pole 102 on a side downstream of the regulating pole 102 with respect to the rotational direction of the first sleeve 33, and hereinafter, the magnetic pole 103 is referred to as a feeding pole 103 in some instances.

Further, the scooping pole 101 is disposed on a side downstream of the delivering pole 107 with respect to the rotational direction of the first sleeve 33 and has the same polarity as that of the delivering pole 107. The delivering pole 107 and the scooping pole 101 form a low-magnetic force portion 110 lower in magnetic force than the delivering pole 107 by a repelling magnetic field generated by cooperation therebetween. By this low-magnetic force portion 110, the developer is peeled off and dropped from the surface of the first sleeve 33, and in addition, the delivery of the developer from the first sleeve 33 to the second sleeve 34 is promoted. Incidentally, the low-magnetic force portion 110 has substantially no magnetic force in this embodiment, but may have a low magnetic force, for example, a magnetic force (normal component Br of magnetic flux density) of 5 mT or less. This is true for a low-magnetic force portion 210 of the second magnet 37 shown in FIG. 4 and for a low-magnetic force portion 310 of the third magnet 38 shown in FIG. 5.

As shown in FIG. 4, the second magnet 37 included in the second developing roller 31 has a magnetic pole structure of 7 poles consisting of a plurality of magnetic poles 201, 202, 203, 204, 205, 206, and 207. Of these magnetic poles, the magnetic pole 201 is a receiving pole for receiving the developer from the first developing roller 30 by the second developing roller 31. The magnetic poles 201 to 207 are disposed in a named order in the rotational direction of the second sleeve 34.

The magnetic pole 201 as the receiving pole is a magnetic pole for attracting the developer from the first sleeve 33 to the second sleeve 34 by a magnetic field generated in cooperation with the magnetic pole 107 of the first magnet 36 of the first developing roller 30, and hereinafter, the magnetic pole 201 is referred to as a receiving pole 201 in some cases. The magnetic pole 207 is a magnetic pole for delivering the developer from the second sleeve 34 to the third sleeve 35 by a magnetic field generated in cooperation with the third magnet 38 of the peeling roller 32.

Further, the receiving pole 201 is an S pole different in polarity from the delivering pole 107 and is used for attracting the developer from the first developing roller 30 (first sleeve 33) to the second sleeve 34 as described above. The magnetic pole 203 is an S pole and is disposed in a position opposing the photosensitive drum 28Y through the second sleeve 34, and is a magnetic pole for developing the electrostatic latent image formed on the photosensitive drum 28Y.

The magnetic poles 202, 204, 205 and 206 are an N pole, an N pole, an S pole, and an N pole, and are used for feeding upward the developer attracted by the magnetic pole 201 with rotation of the second sleeve 34. The magnetic pole 207 is an S pole and delivers the developer, after passing through a developing region with the photosensitive drum 28Y corresponding to the magnetic pole 203, from the second sleeve 34 to the third sleeve 35 opposing the second sleeve 34 by a magnetic field generated in cooperation with a magnetic pole 303 in the third magnet 38 included in the peeling roller 32.

Further, the magnetic pole 207 is disposed on a side upstream of the receiving pole 201 with respect to the rotational direction of the second sleeve 34, and has the same polarity as that of the receiving pole 201. The receiving pole 201 and the magnetic pole 207 form the low-magnetic force portion 210 lower in magnetic force than the magnetic pole 207 by a repelling magnetic field generated by cooperation therebetween. By this low-magnetic force portion 210, the developer is peeled off, and dropped from the surface of the second sleeve 34, and in addition, delivery of the developer from the first sleeve 33 to the second sleeve 34 is promoted. Further, by the low-magnetic force portion 210, it is possible to prevent attraction of the developer to the closest portion between the first sleeve 33 and the second sleeve 34, so that pressure exerted on the developer can be suppressed.

As shown in FIG. 5, the third magnet 38 included in the peeling roller 32 is provided with the plurality of magnetic poles 301, 302, 303, 304, and 305. The magnetic poles 301 to 305 are disposed in a named order in the rotational direction of the third sleeve 35.

The magnetic pole 303 is an N pole different in polarity from the magnetic pole 207 and is used for attracting the developer, peeled off from the second sleeve 34 as described above, to the third sleeve 35. The magnetic poles 301, 302, and 304 are an N pole, an S pole, and an S pole, and are used for feeding the developer on the third sleeve 35 with rotation of the third sleeve 35. Particularly, the magnetic pole 304 is used for feeding downward the developer attracted by the magnetic pole 303 with rotation of the third sleeve 35. The magnetic pole 305 is an N pole and is a peeling pole used for peeling off the developer, attracted to the third sleeve 35, from the third sleeve 35 by a repelling magnetic field generated in cooperation with the magnetic pole 301 which is the same pole.

### [Layer Thickness Regulation of Developer]

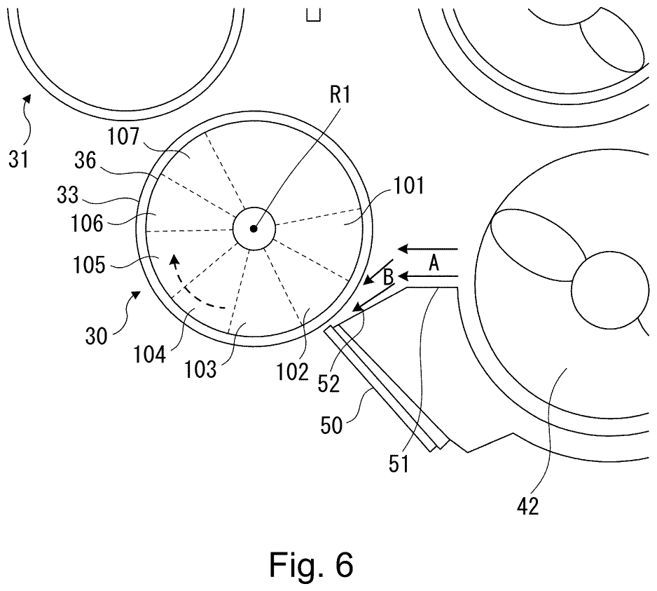

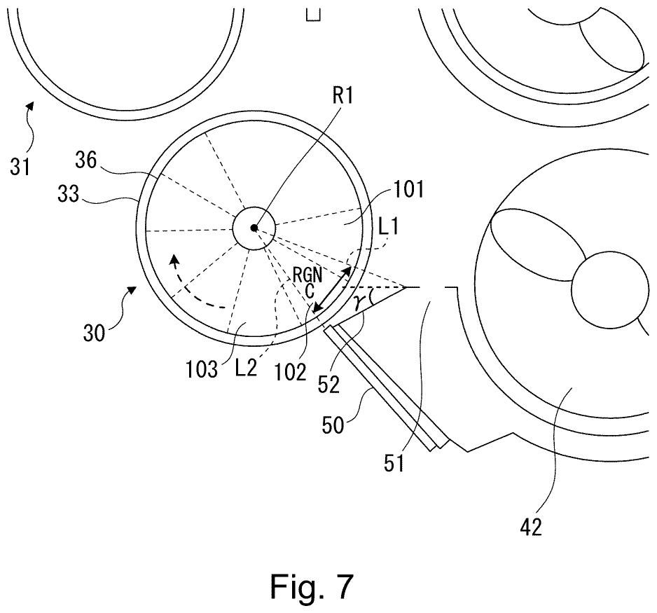

Next, using FIG. 6, regulation of an amount of a developer carried on the first developing roller 30, i.e., regulation of layer thickness of the developer will be described. FIG. 6 is a schematic structural sectional view of a periphery of the first developing roller 30 and the developer supplying screw 42, and arrows A and B show directions in which the developer supplied from the developer supplying screw 42 to the first developing roller 30 flows. Broken lines in the first magnet 36 in FIG. 6 and FIG. 7 described later show magnet pieces corresponding to the respective magnetic poles constituting the first magnet 36. Between the developer supplying screw 42 and the first developing roller 30, the spatial capacity regulating portion 51, the inclined portion 52, and the regulating member 50 are disposed.

The regulating member 50 is disposed through a gap with the first developing roller 30 in a position opposing the regulating pole 102 of the first developing roller 30. In this embodiment, the regulating member 50 is disposed so as to oppose the outer peripheral surface of the first sleeve 33 with a predetermined gap therebetween on a side below the rotation center R1 of the first sleeve 33 of the first developing roller 30 in the vertical direction and upstream of a lowest point, in the vertical direction, of the first sleeve 33 with respect to the rotational direction of the first sleeve 33, and regulates the amount of the developer carried on the first sleeve 33. In other words, the regulating member 50 is positioned below the rotation center R1 of the first sleeve 33 and on a side where the developer supplying screw 42 in provided relative to the rotation center R1, and is used for regulating the amount of the developer supplied from the developer circulating portion 46 to the first developing roller 30.

The spatial capacity regulating portion 51 is used for regulating a spatial capacity defining a developer accumulation amount between the first developing roller 30 and the developer supplying screw 42. In the case where there is no spatial capacity regulating portion 51, the developer in a large amount is supplied from the developer supplying screw 42 toward the regulating pole 102 and the regulating member 50, and a larger developer stagnation is formed, so that promotion of deterioration of the developer and an occurrence of non-uniformity of a developer layer thickness due to pressing non-uniformity of a blade of the developer supplying screw 42 are caused, and there is a liability that density non-uniformity occurs. The developer stirred and fed by the developer supplying screw 42 is attracted from an upper portion of the spatial capacity regulating portion 51 to the scooping pole 101 in a direction of the arrow A.

Further, on the first developing roller 30 side relative to the spatial capacity regulating portion 51, the inclined portion 52 inclined downward toward the regulating member 50 is provided. The inclined portion 52 is inclined downward in the vertical direction as the inclined portion 52 approaches from an end portion of the spatial capacity regulating portion 51 toward the first developing roller 30. The developer carried on the surface of the first sleeve 33 by the scooping pole 101 is fed so as to slid down the inclined portion 52 in a direction of the arrow B toward the regulating pole 102 and the regulating member 50 by rotation of the first sleeve 33. The developer regulated in layer thickness by passing through a gap between the first developing roller 30 and the regulating member 50 in the regulating pole 102 is fed to the feeding pole 103 and the magnetic poles 104 and 105, the develops the electrostatic latent image on the photosensitive drum 28Y opposing the first developing roller 30 in the magnetic pole 105.

At this time, the flows of the developer along the arrows A and B depend on magnetic forces formed by the respective magnetic poles of the first developing roller 30. The flow the developer along the arrow A has the influence on a thickness of a layer formed by the regulating member 50, and therefore, when a feeding amount of the developer along the arrow below lowers, regulation of the layer thickness of the developer by the regulating member 50 cannot be stably performed. Particularly, the developer deteriorated by use lowers in flowability. Then, with the lowering in flowability of the developer, the layer thickness becomes small, so that there is a liability that a lowering in image density occurs.

Therefore, in this embodiment, a magnetic force Fθ- of the first developing roller 30 in a developer feeding direction (tangential direction of the first developing sleeve) in a range of a region C shown in FIG. 7 is strengthened, whereby a feeding property of the developer is improved. FIG. 7 is a schematic view similar to that of FIG. 6, and is the synthetic view for illustrating the region C (“RGN C” in FIG. 7). The region C shows a relationship between the regulating member 50, the inclined portion 52, and the first developing roller 30. That is, the region C is a region on the surface of the first sleeve 33 in a range, with respect to the rotational direction of the first sleeve 33, sandwiched between a line L1 connecting the rotation center R1 of the first sleeve 33 and a starting point (end portion on the spatial capacity regulating portion 51 side) of downward inclination of the inclined portion 52 and a line L2 connecting the rotation center R1 of the first sleeve 33 and a free end of the regulating member 50.

A setting of the magnetic force as described above is made by adjusting an absolute value and inclination of magnetic flux density Br. The adjustment of this magnetic flux density Br can be performed when the first magnet 36 is magnetized. Incidentally, for example, a magnitude, a shape, and the like of a plurality of magnet pieces constituting the first magnet 36 are also adjusted in some cases.

The magnetic force is acquired by the following calculation method. The magnetic force acting on the carrier is acquired by the following formula (1). Here, μ0 is space permeability (absolute permeability of vacuum), μ is permeability of the carrier, b is a radius of the carrier, and B is magnetic flux density.

$$\vec{F} \frac{- μ - {μ}_{0}}{{μ}_{0} ( μ + 2 μ )} 2 π {b}^{3} ∇ {B}^{2} \qquad ( 1 )$$

Accordingly, the following formula (2) is obtained.

$$\vec{F} α ∇ {B}^{2} = \frac{θ}{\partial r} ( B {r}^{2} + B {θ}^{2} ) \vec{{e}_{r}} + \frac{1}{r} \frac{\partial }{\partial θ ( {B}_{r}^{2} + {B}_{θ}^{2} )} \vec{{e}_{θ}} \qquad ( 2 a )$$

$$∴ F ∝ {\underbrace{( Br \frac{\partial B r}{\partial r} + B θ \frac{\partial B θ}{\partial r} ) \vec{{e}_{r}}}}_{Fr} + {\underbrace{\frac{1}{r} ( B r \frac{\partial B r}{\partial θ} + B θ \frac{\partial B θ}{\partial θ} ) \vec{{e}_{θ}}}}_{F θ}$$

In the formula (2), Br is magnetic flux density in a normal direction to the surface of the first developing roller 30, and Be is magnetic flux density in a tangential direction of the surface of the first developing roller 30.

From the above-described formula (2), when Br and Be are known, Fr and Fθ can be acquired.

Here, the magnetic flux density Br is measured by using, as a measuring device, a magnetic field measuring device (“MS-9902” (trade name)), manufactured by F. W. BELL and by setting a distance between a probe which is a member of the measuring device and a surface of the developing sleeve to about 10 μm.

Further, Bθ can be acquired in the following manner. Vector potential AZ(R, θ) in a measuring position of the magnetic flux density Br is acquired by the following formula (3).

$${A}_{z} ( R , θ ) = {\int }_{θ}^{θ} RBrd θ \qquad ( 3 )$$

By using AZ(R,θ) as a boundary condition, an equation ∇2AZ(R,θ)=0 is solved, so that AZ(R,θ) is acquired. Then, by the following formula (4), Bθ can be acquired.

$${B}_{θ} = - \frac{\partial {A}_{z} ( r , θ )}{\partial r} \qquad ( 4 )$$

From the above, Br and Be measured and calculated are applied to the formula (1), so that Fr and Fθ can be derived. A setting of such a magnetic force is made by adjusting an absolute value and a peak position of magnetic flux density Br of the scooping pole and the regulating pole.

In the case of this embodiment, an absolute value of a maximum value of a normal component of magnetic flux density of the regulating pole 102 on the first sleeve 33 is made higher than an absolute value of a maximum value of a normal component of magnetic flux density of the scooping pole 101 on the first sleeve 33. And, an absolute value of a maximum value of a normal component of magnetic flux density of the feeding pole 103 on the first sleeve 33 is made higher than the absolute value of the maximum value of the normal component of the magnetic flux density of the regulating pole 102 on the first sleeve 33. That is, a relationship in magnitude of the absolute value |Br| of the maximum value of the normal component of the magnetic flux density of each of the magnetic poles on the first sleeve 33 satisfy:

(scooping pole 101)<(regulating pole 102)<(feeding pole 103).

### Embodiment 1

As an embodiment in which the relationship of this embodiment is satisfied, first, an embodiment 1 will be described. In the embodiment 1, as shown in table 1 below, the relationship in magnitude of the absolute value |Br| of the maximum value of the normal component of the magnetic flux density of each of the magnetic poles on the first sleeve 33 was set so as to satisfy:

(scooping pole 101)<(regulating pole 102)<(feeding pole 103).

In the following description, the magnitude relationship as in the above-described formula shows the relationship in magnitude of the absolute value |Br| of the maximum value of the normal component of the magnetic flux density of each of the magnetic poles on the first sleeve 33.

TABLE 1

| | Scooping | Regulating | Feeding |
|---|---|---|---|
| | pole 101 | pole 102 | pole 103 |
| EMB. 1 | 20 mT | 50 mT | 70 mT |
| EMB. 2 | 20 mT | 60 mT | 70 mT |
| COMP. EX. 1 | 40 mT | 30 mT | 70 mT |
| COMP. EX. 2 | 20 mT | 50 mT | 50 mT |

On the other hand, in a comparison example 1, a relationship:

(scooping pole 101)>(regulating pole 102)

was satisfied. That is, in the comparison example 1, the absolute value of the maximum value of the normal component of the magnetic flux density of the regulating pole 102 on the first sleeve 33 is made lower than the absolute value of the maximum value of the normal component of the magnetic flux density of the scooping pole 101 on the first sleeve 33.

Incidentally, in each of the embodiment 1, an embodiment 2 described later, the comparison example 1, and a comparison example 2 described later, an absolute value |Br| of a maximum value of a normal component of magnetic flux density of the magnetic pole 104 on the first sleeve 33 was set to 100 mT. Further, as shown in FIG. 3, a line connecting a position P1 where the absolute value of the normal component of the magnetic flux density of the scooping pole 101 on the first sleeve 33 becomes a maximum value with the rotation center R1 of the first sleeve 33 is defined as a line M1. In addition, a line connecting a position P2 where the absolute value of the normal component of the magnetic flux density of the regulating pole 102 on the first sleeve 33 becomes a maximum value with the rotation center R1 of the first sleeve 33 is defined as a line M2. In this case, a first inter-pole angle α which is an angle (acute angle) formed by the line M1 and the line M2 may preferably be 30° or more. Further, the first inter-pole amount a may preferably be 60° or less. That is, a difference in angle between magnetic pole positions where absolute values |Br| of magnetic flux density of the scooping pole 101 and the regulating pole 102 become maximum may preferably be 30° to 60°, and was set to 40° in this embodiment.

Similarly, a line connecting a position P3 where the absolute value of the normal component of the magnetic flux density of the feeding pole 103 on the first sleeve 33 becomes a maximum value with the rotation center R1 of the first sleeve 33 is defined as a line M3.

In this case, a second inter-pole angle β which is an angle (acute angle) formed by the line M2 and the line M2 may preferably be 30° or more. In addition, the second inter-pole angle β may preferably be 60° or less. That is, difference in angle between magnetic pole positions where absolute values |Br| of magnetic flux density of the regulating pole 102 and the feeding pole 103 become maximum may preferably be 30° to 60°, and was set to 50° in this embodiment. Further, as shown in FIG. 7, an angle (acute angle) γ of the inclined portion 52 relative to the horizontal direction in a state in which the first sleeve 33 is positioned in a position opposing the photosensitive drum 28Y and in which the second sleeve 34 is positioned in a position opposing the photosensitive drum 28 may preferably be made 15° or more. Further, the angle γ may preferably be made 45° or less. That is, the angle of the inclined portion 52 may preferably be 15° to 45°, and was made 30° in this embodiment.

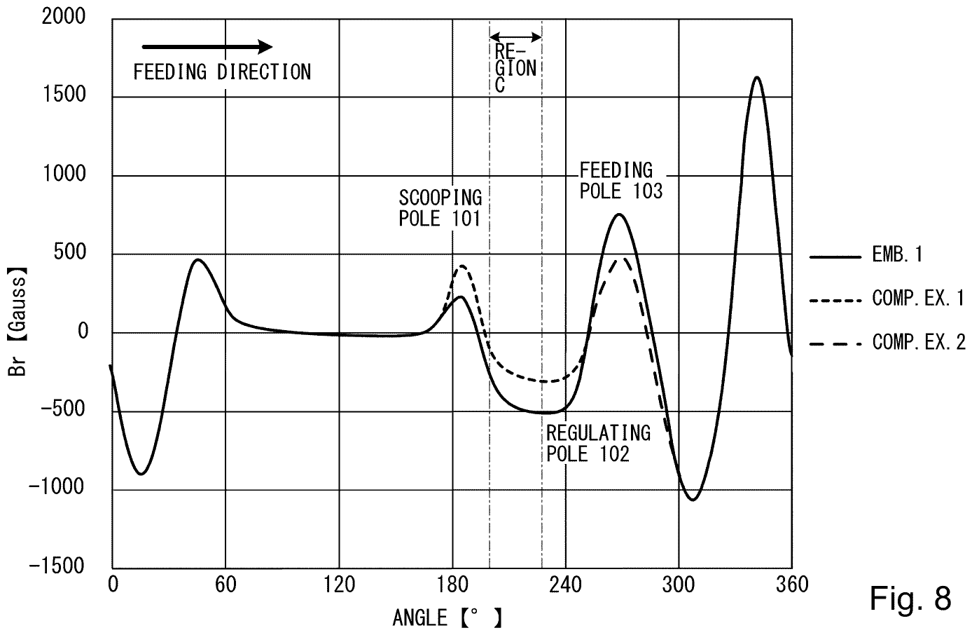

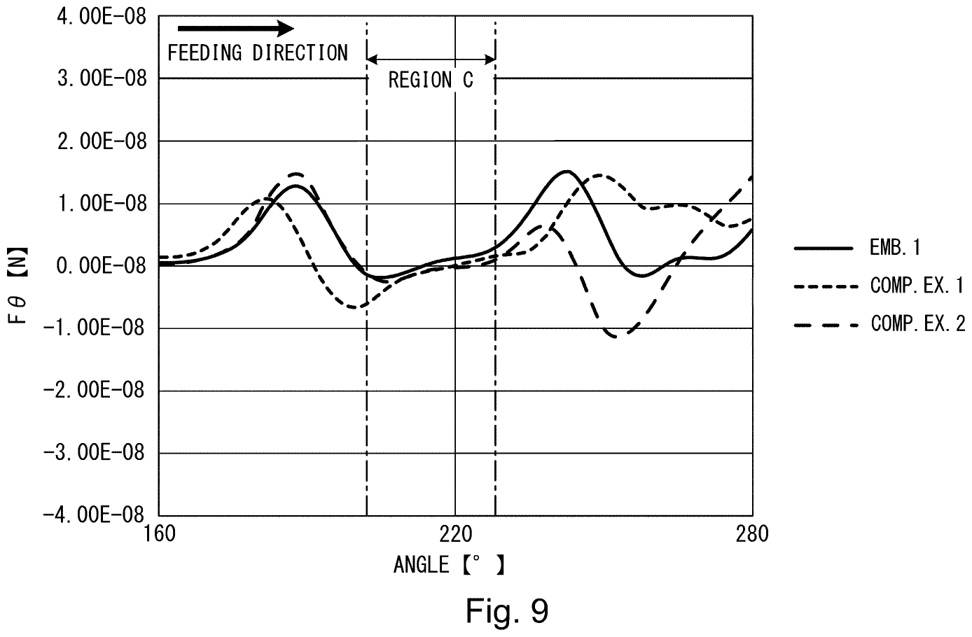

FIG. 8 is a graph showing magnetic flux density Br in a periphery of the regulating pole 102 of the first developing roller 30 in each of the embodiment 1, the comparison example 1, and the comparison example 2. Further, FIG. 9 is a graph showing a magnetic force Fθ in the periphery of the regulating pole 102 of the first developing roller 30 in each of the embodiment 1, the comparison example 1, and the comparison example 2. In FIGS. 8 and 9, the magnetic flux density Br and the magnetic force Fθ in the embodiment 1 are represented by a solid line, the magnetic flux density Br and the magnetic force Fθ in the comparison example 1 are represented by a dotted line, and the magnetic flux density Br and the magnetic force Fθ in the comparison example 2 are represented by a broken line. Further, FIG. 9 shows that a direction of Fθ is a direction toward a downstream side in the rotational direction of the first sleeve 33 in the case where Fe is a positive value and that the direction of Fθ is a direction toward an upstream side in the rotational direction of the first sleeve 33 in the case where Fθ is negative value.

In the comparison example 1, as shown in FIG. 8, relative to the scooping pole 101, the absolute value |Br| of the maximum value of the normal component of the magnetic flux density of the regulating pole 102 is low. For that reason, as shown in FIG. 9, in an upstream end portion of the region C with respect to the rotational direction (developer feeding direction) of the first sleeve 33, a negatively large magnetic force Fθ, i.e., a force for returning the developer from the regulating pole 102 to the scooping pole 101 acts. On the other hand, in the embodiment 1, as shown in FIG. 8, relative to the scooping pole 101, the absolute value |Br| of the maximum value of the normal component of the magnetic flux density of the regulating pole 102 is made high. For this reason, as shown in FIG. 9, Fθ in the region C becomes larger (positive side) than that in the case of the comparison example 1, so that a flow of the developer toward the regulating member 50 can be made smooth.

Here, in the comparison example 2, similarly as in the embodiment 1, the absolute value |Br| of the maximum value of the normal component of the magnetic flux density of the regulating pole 102 was made higher than that of the scooping pole 101, but the absolute value |Br| of the maximum value of the normal component of the magnetic flux density of the feeding pole 103 was made the same as that of the regulating pole 102. In the comparison example 2, as shown in FIG. 9, in an upstream end portion of the region C with respect to the developer feeding direction, Fθ is on the positive side than Fθ in the comparison example 1, but in a central portion and later of the region C with respect to the developer feeding direction, Fθ results in substantially the same value. On the other hand, in the embodiment 1, in the central portion and later of the region C with respect to the developer feeding direction, Fθ is on the positive side than those in the cases of the comparison example 1 and the comparison example 2.

From the above, it is understood that Fθ in the region C can be maintained at a high level by satisfying the following relationship:

(scooping pole 101)<(regulating pole 102)<(feeding pole 103).

For this reason, in the case of this embodiment, feeding of the developer toward the regulating member 50 can be stably performed. That is, the developer carried by the scooping pole 101 be stably fed to the regulating member 50 side below the scooping pole 101 with respect to the vertical direction, so that the layer thickness of the developer can be stabilized for a long term. As a result, an occurrence of a defect (for example, a lowering in darkness (light and dark) in an image visualized from the electrostatic latent image by the toner contained in the developer can be suppressed.

Here, magnitudes of absolute values |Br| of maximum values of normal components of magnetic flux density Br of the respective magnetic poles may desirably provide a difference of 5 mT or more, and may preferably be 10 mT or more. That is, the absolute value |Br| of the maximum value of the normal component of the magnetic flux density of the regulating pole 102 on the first sleeve 33 may preferably be higher than the absolute value |Br| of the maximum value of the normal component of the magnetic flux density of the scooping pole 101 on the first sleeve 33 by 5 mT, more preferably 10 mT or more. In addition, the absolute value |Br| of the maximum value of the normal component of the magnetic flux density of the feeding pole 103 on the first sleeve 33 may preferable be higher than the absolute value |Br| of the maximum value of the normal component of the magnetic flux density of the regulating pole 102 on the first sleeve 33 by 5 mT or more, more preferably 10 mT or more.

This is because there is a liability that when the difference in magnitude of the absolute value |Br| of the maximum value of the normal component of the magnetic flux density Br between the associated magnetic poles is small, depending on a part tolerance of the first magnet 36 of the first developing roller 30, the magnitude relationship of the absolute value |Br| of the maximum value of the normal component of the magnetic flux density between the associated magnetic poles is reversed. For this reason, for example, as in the embodiment 1, Br| of the regulating pole 102 may preferably be made higher than |Br| of the scooping pole 101 by 30 mT or more, and |Br| of the feeding pole 103 may preferably be made higher than |Br| of the regulating pole 102 by 20 mT or more.

Incidentally, in this embodiment, with respect to the rotational direction of the first sleeve 33, the magnetic pole positioned downstream of the regulating pole 102 was the feeding pole 103, but the magnetic pole positioned downstream of the regulating pole 102 may also be a magnetic pole opposing the photosensitive drum 28Y and for developing the electrostatic latent image with the toner in the developer.

### Embodiment 2

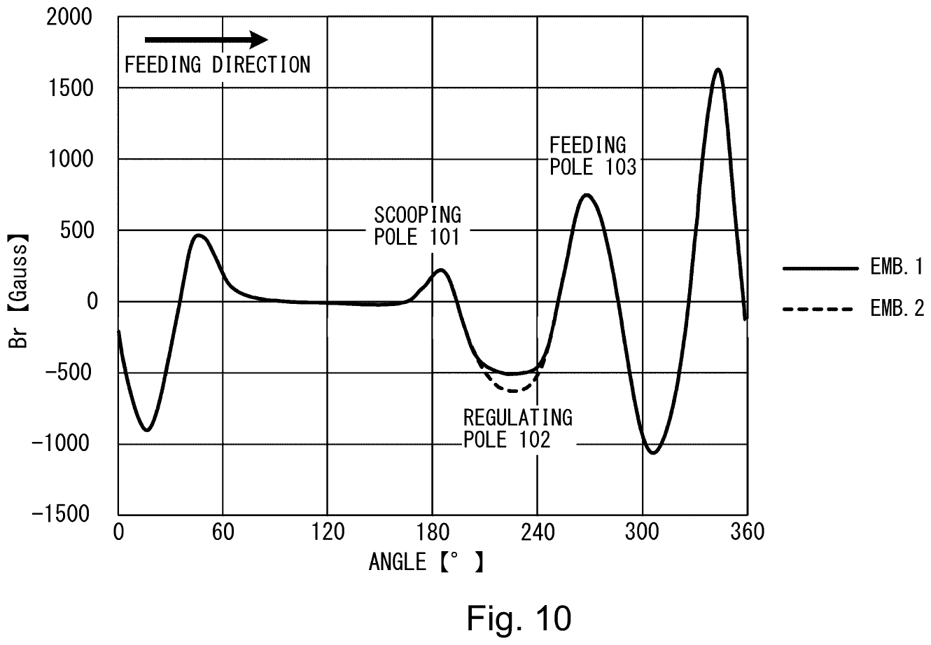

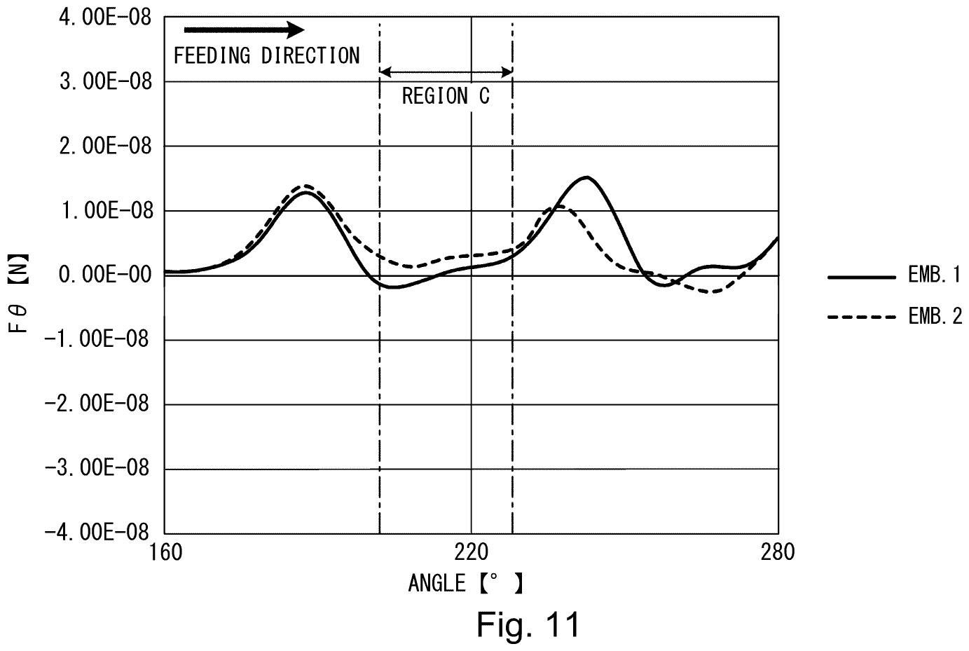

Next, as an embodiment in which the relationship in this embodiment is satisfied, an embodiment 2 will be described using the table 1, FIG. 10, and FIG. 11. In the different between |Br| of the regulating pole 102 and the scooping pole 101 is made larger than that in the embodiment 1. Other constitutions of the embodiment 2 are similar to those in the embodiment 1, and therefore, will be omitted from detailed description.

FIG. 10 is a graph showing magnetic flux density Br in a periphery of the regulating pole 102 of the first developing roller 30 in each of the embodiment 1, and the embodiment 2. Further, FIG. 11 is a graph showing a magnetic force Fθ in the periphery of the regulating pole 102 of the first developing roller 30 in each of the embodiment 1, and the embodiment 2. In FIGS. 10 and 11, the magnetic flux density Br and the magnetic force Fθ in the embodiment 1 are represented by a solid line, and the magnetic flux density Br and the magnetic force Fθ in the embodiment 2 are represented by a dotted line. Further, FIG. 11 shows that a direction of Fθ is a direction toward a downstream side in the rotational direction of the first sleeve 33 in the case where Fθ is a positive value and that the direction of Fθ is a direction toward an upstream side in the rotational direction of the first sleeve 33 in the case where Fθ is negative value.

As shown in FIG. 9, in the embodiment 1, Fθ in the region C is larger than those in the comparison example 1 and the comparison example 2, but Fθ is a negative value in an upstream end portion of the region C with respect to the developer feeding direction and is gradually increased toward a downstream side with respect to the developer feeding direction, i.e., toward a position of the regulating member 50. For this reason, in the embodiment 1, in the upstream end portion of the region C, a force for returning the developer to the scooping pole 101 somewhat acts.

Therefore, in the embodiment 2, the magnitude relationship of the absolute value |Br| of the maximum value of the normal component of the magnetic flux density between the associated magnetic poles is set, similarly as in the embodiment 1, so as to satisfy:

(scooping pole 101)<(regulating pole 102)<(feeding pole 103), and

a difference between |Br| of the scooping pole 101 and |Br| of the regulating pole 102 is made large so that Fθ in the region C becomes larger. As shown in FIG. 11, it is understood that Fθ in the embodiment 2 always becomes a positive value and thus the flow of feeding of the developer can be made better. That is, in the embodiment 2, a direction of the magnetic force Fθ in the tangential direction on the first sleeve 33 is a direction downstream a downstream side with respect to the rotational direction of the first sleeve 33 over an entire area of the region C. For this reason, for example, [Br] of the regulating pole 102 may preferably be made higher than |Br| of the scooping pole 101 by 40 mT or more.

From the above, the feeding of the developer to the regulating member 50 can be stably performed by satisfying the relationship of: (scooping pole 101)<(regulating pole 102)<(feeding pole 103) and by making the difference in |Br| between the scooping pole 101 and the regulating pole 102. As a result of this, the layer thickness of the developer can be more stabilized, so that it is possible to further suppress an occurrence of a defect (for example, a lowering in darkness (light and dark) in an image visualized from the electrostatic latent image by the toner contained in the developer.

### Other Embodiments

The present disclosure is not limited to the constitution of the above-described embodiment. For example, the image forming apparatus 100 is not limited to the MFP, but may also be a copying machine, a printer, or a facsimile machine. Further, the constitutions of the developer supplying screw 42, the developer stirring screw 43, and the developer collecting screw 44 are not particularly limited when the constitutions can convey the developer, and for example, it is possible to apply a helical blade, a paddle-like blade.

Further, the above-described embodiments were described on the case where two developing rollers consisting of the first developing roller 30 and the second developing roller 31 are disposed, but a similar effect is obtained even in the case where a single (one) developing roller 31 is disposed.

Further, the above-described embodiments were described on the case where the seven magnetic poles (the number of magnetic poles: 7) of the first magnet 36 included in the first developing roller 30 are disposed, but even in the number of magnetic poles is five (magnetic poles) by decreasing each of the N pole and the S pole by one.

According to the present disclosure, it is possible to stably feed the developer toward the regulating portion for regulating the amount of the developer carried on the outer peripheral surface of the rotatable developing member.

With the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-228738 filed on Dec. 25, 2024, which is hereby incorporated by reference herein in its entirety.

What is claimed is:

1. A developing device comprising:
a developing container configured to accommodate a developer including toner and a carrier;
a rotatable developing member configured to carry and feed the developer to a developing position where an electrostatic latent image formed on an image bearing member is developed;
a supplying screw configured to supply the developer to the rotatable developing member while stirring and feeding the developer;
a regulating portion configured to regulate an amount of the developer carried on an outer peripheral surface of the rotatable developing member, the regulating portion being positioned below a rotation center of the rotatable developing member with respect to a vertical direction and upstream of a lowest point of the rotatable developing member with respect to a rotational direction of the rotatable developing member;
a magnet provided non-rotatably and stationarily inside the rotatable developing member, the magnet including
a regulating pole provided opposed to the regulating portion,
an upstream pole provided upstream of the regulating pole and adjacent to the regulating pole, with respect to the rotational direction of the rotatable developing member, and having a polarity different from that of the regulating pole, and
a downstream pole provided downstream of the regulating pole and adjacent to the regulating pole, with respect to the rotational direction of the rotatable developing member, and having a polarity different from that of the regulating pole; and
an inclined portion inclined downward in a vertical direction toward the regulating portion, wherein
a starting point of inclination of the inclined portion downward in the vertical direction is positioned below, in the vertical direction, a point on the outer peripheral surface of the rotatable developing member where an absolute value of magnetic flux density of the upstream pole in a normal direction to the outer peripheral surface of the rotatable developing member becomes a maximum value, and above the regulating portion in the vertical direction, and
the starting point of inclination of the inclined portion downstream in the vertical direction is positioned between the supplying screw and the rotatable developing member with respect to a horizontal direction,
wherein an absolute value of a maximum value of magnetic flux density of the regulating pole in a normal direction to the outer peripheral surface of the rotatable developing member is higher than the absolute value of the maximum value of the magnetic flux density of the upstream pole in the normal direction to the outer peripheral surface of the rotatable developing member, and
wherein an absolute value of a maximum value of magnetic flux density of the downstream pole in a normal direction to the outer peripheral surface of the rotatable developing member is higher than the absolute value of the maximum value of the magnetic flux density of the regulating pole in the normal direction to the outer peripheral surface of the rotatable developing member.

2. The developing device according to claim 1, wherein the absolute value of the maximum value of the magnetic flux density of the regulating pole in the normal direction to the outer peripheral surface of the rotatable developing member is higher than the absolute value of the maximum value of the magnetic flux density of the upstream pole in the normal direction to the outer peripheral surface of the rotatable developing member by 5 mT or more.

3. The developing device according to claim 1, wherein the absolute value of the maximum value of the magnetic flux density of the regulating pole in the normal direction to the outer peripheral surface of the rotatable developing member is higher than the absolute value of the maximum value of the magnetic flux density of the upstream pole in the normal direction to the outer peripheral surface of the rotatable developing member by 10 mT or more.

4. The developing device according to claim 1, wherein the absolute value of the maximum value of the magnetic flux density of the regulating pole in the normal direction to the outer peripheral surface of the rotatable developing member is higher than the absolute value of the maximum value of the magnetic flux density of the upstream pole in the normal direction to the outer peripheral surface of the rotatable developing member by 30 mT or more.

5. The developing device according to claim 1, wherein the absolute value of the maximum value of the magnetic flux density of the downstream pole in the normal direction to the outer peripheral surface of the rotatable developing member is higher than the absolute value of the maximum value of the magnetic flux density of the regulating pole in the normal direction to the outer peripheral surface of the rotatable developing member by 5 mT or more.

6. The developing device according to claim 1, wherein the absolute value of the maximum value of the magnetic flux density of the downstream pole in the normal direction to the outer peripheral surface of the rotatable developing member is higher than the absolute value of the maximum value of the magnetic flux density of the regulating pole in the normal direction to the outer peripheral surface of the rotatable developing member by 10 mT or more.

7. The developing device according to claim 1, wherein the absolute value of the maximum value of the magnetic flux density of the downstream pole in the normal direction to the outer peripheral surface of the rotatable developing member is higher than the absolute value of the maximum value of the magnetic flux density of the regulating pole in the normal direction to the outer peripheral surface of the rotatable developing member by 20 mT or more.

8. The developing device according to claim 1, wherein with respect to the rotational direction of the rotatable developing member, an angle from the point on the outer peripheral surface of the rotatable developing member where the absolute value of the magnetic flux density of the upstream pole in the normal direction to the outer peripheral surface of the rotatable developing member becomes the maximum value to a point on the outer peripheral surface of the rotatable developing member where an absolute value of the magnetic flux density of the regulating pole in the normal direction to the outer peripheral surface of the rotatable developing member becomes a maximum value is 30° or more and 60° or less.

9. The developing device according to claim 1, wherein with respect to the rotational direction of the rotatable developing member, an angle from a point on the outer peripheral surface of the rotatable developing member where an absolute value of the magnetic flux density of the regulating pole in the normal direction to the outer peripheral surface of the rotatable developing member becomes the maximum value to a point on the outer peripheral surface of the rotatable developing member where an absolute value of the magnetic flux density of the downstream pole in the normal direction to the outer peripheral surface of the rotatable developing member becomes a maximum value is 30° or more and 60° or less.

10. The developing device according to claim 1, wherein an acute angle of the inclined portion to the horizontal direction is 15° or more and 45° or less.

11. The developing device according to claim 1, wherein in a case where
of a magnetic force acting on the carrier on the outer peripheral surface of the rotatable developing member, the magnetic force in a tangential direction to the outer peripheral surface of the rotatable developing member is defined as Fθ,
a sign of Fθ when a direction of Fθ is the same direction as the rotational direction of the rotatable developing member is defined as a positive, and
a sign of Fθ when the direction of Fθ is a direction opposite to the rotational direction of the rotatable developing member is defined as a negative,
with respect to the rotational direction of the rotatable developing member, Fθ>0 is satisfied over a range from a point where a line connecting the rotation center of the rotatable developing member and the starting point of inclination of the inclined portion downward in the vertical direction crosses the outer peripheral surface of the rotatable developing member to a point where a line connecting the rotation center of the rotatable developing member and the regulating portion crosses the outer peripheral surface of the rotatable developing member.

12. The developing device according to claim 11, wherein the absolute value of the maximum value of the magnetic flux density of the regulating pole in the normal direction to the outer peripheral surface of the rotatable developing member is higher than the absolute value of the maximum value of the magnetic flux density of the upstream pole in the normal direction to the outer peripheral surface of the rotatable developing member by 40 mT or more.

13. The developing device according to claim 1, wherein the magnet further includes a further upstream pole provided upstream of the upstream pole and adjacent to the upstream pole, with respect to the rotational direction of the rotatable developing member, and having the same polarity as that of the upstream pole.

14. The developing device according to claim 1, further comprising a further rotatable developing member which is provided opposed to the rotatable developing member and to which the developer is delivered from the rotatable developing member by a magnetic field generated by the magnet,
wherein the further rotatable developing member carries and feeds the developer to a further developing position where the electrostatic latent image is developed, and
wherein a rotation center of the further rotatable developing member is positioned above the rotation center of the rotatable developing member in the vertical direction.

15. The developing device according to claim 14, wherein in a position where the rotatable developing member and the further rotatable developing member oppose each other, a rotational direction of the further rotatable developing member is opposite to the rotational direction of the rotatable developing member.

16. A developing device comprising:
a developing container configured to accommodate a developer including toner and a carrier;
a rotatable developing member configured to carry and feed the developer to a developing position where an electrostatic latent image formed on an image bearing member is developed;
a supplying screw configured to supply the developer to the rotatable developing member while stirring and feeding the developer;
a regulating portion configured to regulate an amount of the developer carried on an outer peripheral surface of the rotatable developing member, the regulating portion being positioned below a rotation center of the rotatable developing member with respect to a vertical direction and upstream of a lowest point of the rotatable developing member with respect to a rotational direction of the rotatable developing member;
a magnet provided non-rotatably and stationarily inside the rotatable developing member, the magnet including
a regulating pole provided opposed to the regulating portion,
an upstream pole provided upstream of the regulating pole and adjacent to the regulating pole, with respect to the rotational direction of the rotatable developing member, and having a polarity different from that of the regulating pole, and
a downstream pole provided downstream of the regulating pole and adjacent to the regulating pole, with respect to the rotational direction of the rotatable developing member, and having a plurality different from that of the regulating pole; and
an inclined portion inclined downward in a vertical direction toward the regulating portion, wherein
a starting point of inclination of the inclined portion downward in the vertical direction is positioned below, in the vertical direction, a point on the outer peripheral surface of the rotatable developing member where an absolute value of magnetic flux density of the upstream pole in a normal direction to the outer peripheral surface of the rotatable developing member becomes a maximum value, and above the regulating portion in the vertical direction, and
the starting point of inclination of the inclined portion downstream in the vertical direction is positioned between the supplying screw and the rotatable developing member with respect to a horizontal direction,
wherein in a case where
of a magnetic force acting on the carrier on the outer peripheral surface of the rotatable developing member, the magnetic force in a tangential direction to the outer peripheral surface of the rotatable developing member is defined as Fθ,
a sign of Fθ when a direction of Fθ is the same direction as the rotational direction of the rotatable developing member is defined as a positive, and
a sign of Fθ when the direction of Fθ is a direction opposite to the rotational direction of the rotatable developing member is defined as a negative,
with respect to the rotational direction of the rotatable developing member, Fθ>0 is satisfied over a range from a point where a line connecting the rotation center of the rotatable developing member and the starting point of inclination of the inclined portion downward in the vertical direction crosses the outer peripheral surface of the rotatable developing member to a point where a line connecting the rotation center of the rotatable developing member and the regulating portion crosses the outer peripheral surface of the rotatable developing member.

17. The developing device according to claim 16, wherein the absolute value of the maximum value of the magnetic flux density of the regulating pole in the normal direction to the outer peripheral surface of the rotatable developing member is higher than the absolute value of the maximum value of the magnetic flux density of the upstream pole in the normal direction to the outer peripheral surface of the rotatable developing member by 40 mT or more.

18. The developing device according to claim 16, wherein the magnet further includes a further upstream pole provided upstream of the upstream pole and adjacent to the upstream pole, with respect to the rotational direction of the rotatable developing member, and having the same polarity as that of the upstream pole.

19. The developing device according to claim 16, further comprising a further rotatable developing member which is provided opposed to the rotatable developing member and to which the developer is delivered from the rotatable developing member by a magnetic field generated by the magnet,
wherein the further rotatable developing member carries and feeds the developer to a further developing position where the electrostatic latent image is developed, and
wherein a rotation center of the further rotatable developing member is positioned above the rotation center of the rotatable developing member in the vertical direction.

20. The developing device according to claim 19, wherein in a position where the rotatable developing member and the further rotatable developing member oppose each other, a rotational direction of the further rotatable developing member is opposite to the rotational direction of the rotatable developing member.
